(19) United States
(12) Patent Application Publication
(10) Pub. No.: US 2026/0027657 A1
(43) Pub. Date: Jan. 29, 2026

(54) SYSTEM AND METHODS FOR LABELING CONFECTIONARY PRODUCTS WITH LASER-ETCHING

(71) Applicant: Mars, Incorporated, McLean, VA (US)

(72) Inventors: Richard AMMENDOLA, Naperville, IL (US); Peter KASHULINES, McLean, VA (US); Frank MESHACH, McLean, VA (US)

(21) Appl. No.: 18/781,374

(22) Filed: Jul. 23, 2024

(51) Int. Cl. B23K 26/362; A23G 7/00; B07C 5/36; B23K 26/08; B23K 26/16

(52) U.S. Cl. CPC B23K 26/362; B07C 5/362; B23K 26/0838; B23K 26/16; A23G 7/005

(57) ABSTRACT

A system may include a conveyor system that transports objects on a transport path from a first end to a second end by rotating about a first axis in a transporting direction. A system may include an inlet adjacent to the first end to group the objects for transportation on the conveyor system. A system may include an outlet adjacent to the second end to sort the objects by separating incomplete objects from whole objects. A system may include a laser system configured to interact with the objects while the objects are on the transport path between the first end and the second end. The laser system may produce a plurality of beam segments such that each beam segment is configured to laser-etch an outer surface of an object.

### TECHNICAL FIELD

This disclosure generally relates to laser-etching confectionary products.

### BACKGROUND

Etching techniques are often used during the manufacturing or production of confectionary products. In particular, etching techniques can be used to create various prints or designs on the confectionary products. One such etching technique can involve the use of laser-etching. Laser-etching uses laser energy to target, ablate, and remove at least part of a substrate included in a given confectionary product. Laser-etching techniques involve complex systems and devices to properly supply an adequate laser to the confectionary products. Often, confectionary products must be rapidly produced, which can cause issues since laser-etching can be a time consuming process. The overall system for producing laser-etched products is further complicated by the fact the conveying system must provide the products in such a way that the laser system can etch quickly enough and provide enough lasers that production is not slowed down. Accordingly, there is an ongoing need for a system or method to laser-etch products in a timely manner.

### SUMMARY

In some aspects, the techniques described herein relate to a system for laser-etching a plurality of objects, the system including: a conveyor system with a transport path that transports the plurality of objects from a first end to a second end, the conveyor system rotating about a first axis in a transporting direction; an inlet adjacent to the first end, the inlet grouping the plurality of objects for transportation on the conveyor system via the transport path; an outlet adjacent to the second end, the outlet sorting the plurality of objects by separating incomplete objects of the plurality of objects from whole objects of the plurality of objects; and a laser system configured to interact with the plurality of objects while the plurality of objects are on the transport path between the first end and the second end, wherein the laser system produces a plurality of beam segments, wherein each beam segment is configured to laser-etch an outer surface of an object of the plurality of objects.

In some aspects, the techniques described herein relate to a system, wherein a hopper and/or a second conveyor system provides the plurality of objects to the inlet.

In some aspects, the techniques described herein relate to a system, wherein the outlet provides the whole objects of the plurality of objects to a collection box and/or a second conveyor system.

In some aspects, the techniques described herein relate to a system, the system further including: a moving apparatus configured to move any one of the plurality of objects on the transport path to space apart the plurality of objects for reception of the plurality of beam segments.

In some aspects, the techniques described herein relate to a system, the system further including: a smoke extraction system configured to remove smoke and/or particulates from the system caused by the laser-etching.

In some aspects, the techniques described herein relate to a system, the system further including: a user interface configured to allow a user of the system to at least turn the laser system on, turn the laser system off, turn the conveyor system on, and turn the conveyor system off.

In some aspects, the techniques described herein relate to a system, wherein the user interface includes a laser system user interface configured to allow the user of the system to control components of the laser system and a conveyor system user interface configured to allow the user of the system to control components of the conveyor system.

In some aspects, the techniques described herein relate to a method for laser-etching a plurality of objects, the method including: supplying the plurality of objects to an inlet adjacent to a first end of a transport path of a conveyor system; transporting the plurality of objects from the first end to a second end of the transport path via the conveyor system, the conveyor system rotating about a first axis in a transporting direction; laser-etching the plurality of objects via a laser system, wherein the laser system produces a plurality of beam segments, and wherein each beam segment of the plurality of beam segments is directed onto an outer surface of an object of the plurality of objects such that each beam segment laser-etches the outer surface of the object; and sorting the plurality of objects after being laser-etched at an outlet adjacent to the second end of the transport path of the conveyor system, wherein the sorting includes separating incomplete objects of the plurality of objects from whole objects of the plurality of objects.

In some aspects, the techniques described herein relate to a method, wherein the outlet is configured to provide the whole objects of the plurality of objects to a second conveyor system.

In some aspects, the techniques described herein relate to a method, the method further including: extracting smoke and/or particulates generated from the laser-etching via a smoke extraction system.

In some aspects, the techniques described herein relate to a method, the method further including: controlling, via a user interface, the laser system, wherein controlling the laser system includes at least one of turning the laser system on and turning the laser system off.

In some aspects, the techniques described herein relate to a method, the method further including: controlling, via the user interface, the conveyor system, wherein controlling the conveyor system includes at least one of turning the conveyor system on and turning the conveyor system off.

In some aspects, the techniques described herein relate to a method, the method further including: controlling, via a second user interface, the conveyor system, wherein controlling the conveyor system includes at least one of turning the conveyor system on and turning the conveyor system off.

In some aspects, the techniques described herein relate to a system for laser-etching a plurality of objects, the system including: a conveyor system with a transport path that transports the plurality of objects from a first end to a second end, the conveyor system rotating about a first axis in a transporting direction; a moving apparatus configured to move any one of the plurality of objects on top of another one of the plurality of objects on the transport path; a laser system configured to interact with the plurality of objects while the plurality of objects are on the transport path between the first end and the second end, wherein the laser system produces one or more beam segments, and wherein each beam segment of the one or more beam segments is configured to laser-etch an outer surface of an object of the plurality of objects; and a smoke extraction system configured to remove smoke and/or particulates from the system caused by the laser-etching.

In some aspects, the techniques described herein relate to a system, the system further including: an inlet adjacent to the first end, the inlet grouping the plurality of objects for transportation on the conveyor system via the transport path, wherein a hopper and/or a second conveyor system provides the plurality of objects to the inlet.

In some aspects, the techniques described herein relate to a system, the system further including: an outlet adjacent to the second end, the outlet sorting the plurality of objects by separating incomplete objects of the plurality of objects from whole objects of the plurality of objects.

In some aspects, the techniques described herein relate to a system, wherein the outlet provides the whole objects of the plurality of objects to a collection box and/or a second conveyor system.

In some aspects, the techniques described herein relate to a system, the system further including: a user interface configured to allow a user of the system to at least turn the laser system on, turn the laser system off, turn the conveyor system on, and/or turn the conveyor system off.

In some aspects, the techniques described herein relate to a system, wherein the user interface includes a laser system user interface configured to allow the user of the system to control components of the laser system and a conveyor system user interface configured to allow the user of the system to control components of the conveyor system.

In some aspects, the techniques described herein relate to a system, wherein the system is configured to laser-etch at a rate of 750,000 objects per hour.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1A is a side view of a laser-etching system according to aspects of the present disclosure.

FIG. 1B is a perspective view of a laser-etching system according to FIG. 1A.

FIG. 2A is a perspective view of a laser-etching system according to aspects of the present disclosure.

FIG. 2B is a perspective view of a laser-etching system according to FIG. 2A.

FIG. 3 illustrates an implementation of a computer system that executes techniques of a laser-etching system according to aspects of the present disclosure.

FIG. 4 is a flow chart according to aspects of the present disclosure.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “substantially,” “generally,” and “approximately” are used to indicate a possible variation of ±10% in the stated value.

The terms used in this specification generally have their ordinary meanings in the art, within the context of this disclosure and in the specific context where each term is used. Certain terms are discussed below, or elsewhere in the specification, to provide additional guidance in describing the compositions and methods of the disclosure and how to make and use them. As used in the present disclosure, the singular forms “a,” “an” and “the” include plural referents unless the context clearly dictates otherwise.

References to “embodiment,” “an embodiment,” “one embodiment,” “in various embodiments,” “certain embodiments,” “some embodiments,” “other embodiments,” “certain other embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

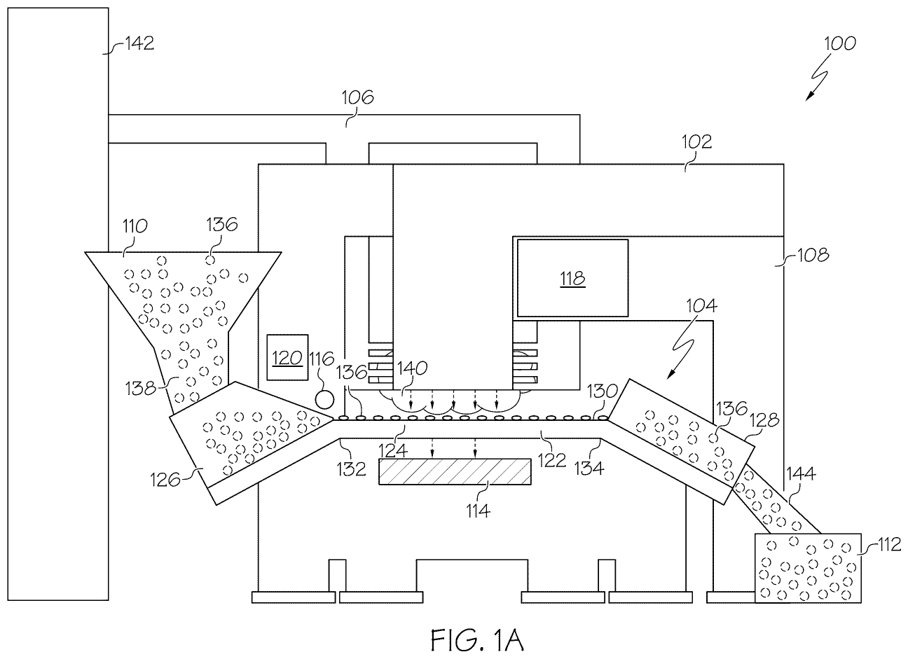

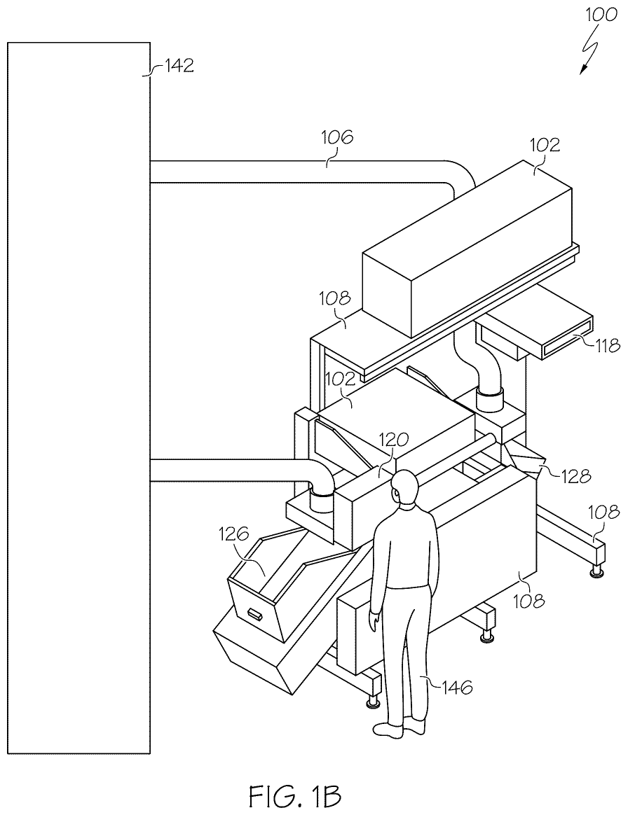

FIG. 1A is a side view of a laser-etching system according to aspects of the present disclosure. FIG. 1B is a perspective view of a laser-etching system according to FIG. 1A with some components from FIG. 1A omitted. Laser-etching system 100 may include a laser system 102, a conveyor system 104, a smoke extraction system 106, a support structure 108, a hopper 110 (FIG. 1A), a collector 112 (FIG. 1A), a laser absorption plate 114 (FIG. 1A), a brush 116 (FIG. 1A), a user interface 118, and a user interface 120. Laser-etching system 100 may be designed for production lines that have restrictive dimensional constraints. In other words, the layout of laser-etching system 100 may be efficiently designed to have little to no wasted space. As seen in FIGS. 1A and 1B, laser-etching system 100 is a compact system capable of producing laser-etched products at a high production rate without having a large physical footprint. Support structure 108 may house laser-etching system 100 and provide the necessary dimensions for laser-etching system 100. That is, support structure 108 may be efficiently designed to keep laser-etching system 100 compact. As seen in FIGS. 1A and 1B, many (if not all) components of laser-etching system 100 are held up by support structure 108. Support structure 108 may be made of any suitable material capable of providing laser-etching system 100 with a durable, strong structure such as any combination of steel, aluminum alloy, cast iron, titanium, etc.

Conveyor system 104 may further include carrier bars 124 and a transport path 130 between an inlet 126 and an outlet 128 with a first end 132 adjacent to inlet 126 and a second end 134 adjacent to outlet 128. Conveyor system 104 may be configured to transport a plurality of product 136 from inlet 126 to outlet 128 via transport path 130. As described herein, plurality of product 136 may be any type of product suitable for laser-etching. Preferably, plurality of product 136 is edible product (e.g., confectionary product) produced for consumers. For example, plurality of product 136 may be a chocolate product, a sweet product, a sugary product, etc. Plurality of product 136 may also be any shape or size. In an aspect, plurality of product 136 is small and has a substantially circular cross-section. In another aspect, plurality of product 136 is large and has a substantially oval cross-section. In yet another aspect, plurality of product 136 is both small and large with several cross-sections including rectangular, circular, and other non-uniform geometric shapes.

Conveyor system 104 may be powered by any way known in the art. For example, conveyor system 104 may be powered by one or more electric motors, hydraulic motors, and/or pneumatic motors. User interface 120 may allow a user (as seen in FIG. 1B) of the laser-etching system 100 (or simply the conveyor system 104) to control conveyor system 104 and/or other components of laser-etching system 100 as described below.

Conveyor system 104 may facilitate the transportation process of the plurality of product 136. Conveyor system 104 may rotate about a first axis (e.g., the axis that is normal to the page in FIG. 1A) in a transporting direction. For example, with respect to FIG. 1A, conveyor system 104 may rotate clockwise about the first axis such that objects (e.g., product) are conveyed (e.g., transported) from left (e.g., inlet 126) to right (e.g., outlet 128). In this way, conveyor system 104 facilitates the movement of plurality of product 136 on transport path 130 from first end 132 to second end 134. In an aspect, conveyor system 104 is one conveyor system that goes around inlet 126, transport path 130, and outlet 128. In another aspect, conveyor system 104 is three separate conveyor systems, one of which goes around inlet 126, one of which goes around transport path 130, and one of which goes around outlet 128. Further, a conveyor system may not be supplied to outlet 128 and, instead, outlet 128 may be angled such that gravity moves the plurality of product 136 from second end 134 through outlet 128 and to collector 112. In an embodiment, outlet 128 includes a conveyor system and is angled such that gravity assists moving the plurality of product 136. Conveyor system 104 may be made up of carrier bars 124 such that the plurality of product 136 contact and are transported on carrier bars 124.

Specifically, carrier bars 124 may attach to conveyor system 104 via a “snap-in pin” system. Carrier bars 124 may be secured to conveyor system 104 in any way known in the art such as clamps, clips, adhesive, magnets, hooks, straps, bolts, screws, etc. In some aspects, carrier bars 124 may be provided over a conveyor belt 122 of conveyor system 104. Carrier bars 124 may assist in organizing plurality of product 136 for proper transportation through laser-etching system 100. Since laser system 102 interacts with plurality of product 136, plurality of product 136 may be preferably provided to laser system 102 in a way that the laser beams of laser system 102 can quickly and properly laser-etch an outer surface of plurality of product 136.

For example, if plurality of product 136 were transported on transport path 130 in a pile, with some product entirely covering and/or substantially overlapping others, laser system 102 would be unable to laser-etch each product. It would be time-consuming and inefficient to sort out product that was not laser-etched to then supply them to laser system 102 once again. Thus, carrier bars 124 provide an efficient way to organize the plurality of product 136 for laser system 102 to enable a high production rate for laser-etching system 100.

Carrier bars 124 may include a plurality of cavities for the plurality of product 136 to sit at least partially within. Each cavity of the plurality of cavities of the carrier bars 124 may be shaped to allow only one product of the plurality of product 136 to fit within the cavity. The plurality of cavities may be deep enough such that the plurality of product 136 are entirely within the cavities (e.g., the tops of the plurality of product 136 are at or below the surface of carrier bars 124). Alternatively, the plurality of cavities may be shallow such that the plurality of product 136 are only partially within the cavities (e.g., the tops of the plurality of product 136 are above the surface of carrier bars 124). Brush 116 (e.g., a moving apparatus) may assist in ensuring the plurality of product 136 find respective cavities to fit within prior to being laser-etched. In general, moving apparatus 116 may be configured to space apart plurality of product 136.

This may be achieved, for example, by brush 116 being placed at a certain distance above carrier bars 124 at a location prior to laser system 102 such that brush 116 physically contacts only the product that are on top of other product and/or product that are not within respective cavities. Preferably, brush 116 is located at first end 132 so that product that contacts brush 116 may simply fall back into (e.g., return to) inlet 126 and/or be brushed into open cavities on transport path 130. In this way, product that are not properly provided to transport path 130 will continue to stay in inlet 126 until they find open cavities of the carrier bars 124. Brush 116 may not be a brush but simply any apparatus configured to help place plurality of product 136 within the plurality of cavities (e.g., paddles, air blowers, vacuums, rollers, mechanical grippers, etc.).

In the embodiments where conveyor system 104 is split into three separate conveyor systems, carrier bars 124 may be provided only for the conveyor system that goes around transport path 130. Additionally, carrier bars 124 may be provided for the conveyor system that goes around inlet 126 and/or outlet 128.

Laser system 102 may provide laser beams directly above transport path 130 of conveyor system 104 (e.g., a path that product is conveyed/transported by the conveyor system to the laser system) to laser-etch outer surfaces of a plurality of product 136 (e.g., objects). Specifically, laser system 102 may include one or more laser sources, one or more beam splitters, and one or more beam deflectors. The one or more laser sources of laser system 102 may emit one or more laser beams. These laser beams are configured to ablate the outer surface of the product supplied to laser-etching system 100. The laser beams are split into a plurality of beam segments via the one or more beam splitters. The one or more beam splitters may be any device known in the art such as plate beam splitters, cube beam splitters, polarizing beam splitters, dichroic beam splitters, or any combination thereof. Preferably, the one or more beam splitters of laser system 102 split the laser beams into beam segments of the same (or nearly the same) strength.

The plurality of beam segments may then be directed to individual cavities of the carrier bars 124 to laser-etch the product within each cavity. The beam segments are directed by one or more beam deflectors, such as one or more galvanometers. In case of an emergency and/or an errant laser beam segment, laser absorption plate 114 may be provided below conveyor system 104 (e.g., below the transport path 130 where laser system 102 laser-etches plurality of product 136) to protect the rest of laser-etching system 100. Laser absorption plate 114 is made of any suitable material capable of absorbing the laser beam segments generated by laser system 102.

Laser system 102 may be housed in a large box held up by support structure 108 above conveyor system 104. The laser beam segments are directed to a portion of transport path 130 that smoke extraction system 106 is connected to. Because laser-etching the product may create fumes, smoke, particulates, and other potentially hazardous by-products 140, laser-etching system 100 may have a smoke extraction system 106 that can extract (e.g., remove) the hazardous by-products 140 from laser-etching system 100. In the example shown in FIG. 1A, smoke extraction system 106 is made of pipes with a pump (e.g., vacuum) system to create an air flow within the pipes. Hazardous by-products 140 are extracted from laser-etching system 100 at the transport path 130 where the laser-etching occurs to outside environment 142 via smoke extraction system 106. Outside environment 142 may be an outside containment area, a filtration system, a fan, or any other suitable way to release hazardous by-products 140.

Laser system 102 may be powered by any way known in the art. For example, laser system 102 may be powered by electricity from various sources (e.g., fossil fuels, solar, wind, hydro, etc.). User interface 118 may allow a user 146 (as seen in FIG. 1B) of the laser-etching system 100 (or simply the laser system 102) to control laser system 102 and/or other components of laser system 102 as described below.

Inlet 126 may be adjacent to first end 132 such that inlet 126 supplies the plurality of product 136 to the transport path 130 for laser-etching via laser system 102. Inlet 126, as better seen in FIG. 1B, may have side walls and a back wall to create a housing with an open top. Thus, plurality of product 136 are provided to the top of inlet 126 via hopper 110 (e.g., a chute 138 connected to hopper 110). Inlet 126 may be angled such that the end of inlet 126 that is adjacent to transport path 130 is higher than the opposite end.

This allows the plurality of product 136 to group within inlet 126 and ensures product only enters the transport path 130 when the conveyor system 104 is configured to transport product. It also allows product to naturally fall back into inlet 126 if the product is not secured within a cavity of the carrier bars 124. The walls of inlet 126 may be tall enough that a large amount of product can stay within inlet 126 and not overflow, and so any product that is sent back to the inlet 126 by brush 116 does not fall out. In an example, the inlet 126 is provided at a 45 degree incline. In an example, inlet 126 is provided at a 30 degree incline. In an example, inlet 126 is provided at a 60 degree angle. The incline of inlet 126 may be any degree within the range of 25-65 degrees.

Hopper 110 may supply plurality of product 136 to laser-etching system 100 at the inlet 126. Hopper 110 may use and/or include a chute 138 that properly directs each product into inlet 126. Hopper 110 may have a large opening at the top (as shown in FIG. 1A) and a substantially smaller opening at the bottom that connects to inlet 126 directly or to chute 138. In this way, hopper 110 may be an upside down cone shape. Hopper 110 may be a conventional hopper known in the art, or may be a conveyor system from another machine. For example, laser-etching system 100 is one of several systems in a production line while hopper 110 is the outlet of another system. The present disclosure contemplates any device capable of supplying laser-etching system 100 with the product for hopper 110.

Outlet 128 may be adjacent to second end 134 such that outlet 128 groups the plurality of product 136 after being laser-etched by laser system 102. As previously mentioned, outlet 128 may be angled such that plurality of product 136 fall from transport path 130 into outlet 128 (e.g., the side of outlet 128 adjacent to transport path 130 may be higher than the opposite side so gravity causes the plurality of product 136 to move within and/or through outlet 128. Outlet 128 may have a first end adjacent to transport path 130 and a second end opposite to the first end. Both the first end and the second end may have openings configured to allow plurality of product 136 through. Outlet 128 may have walls surrounding the openings between first end and second end. In this way, outlet 128 may be completed surrounded by sidewalls with openings on opposite ends.

Outlet 128 may have a sorting function and/or include a device capable of performing a sorting function as described herein. Within outlet 128, plurality of product 136 may be sorted by separating whole products from partial or cracked products. Any broken pieces, partial pieces, cracked pieces, etc. of plurality of product 136 are separated from complete pieces of plurality of product 136. The incomplete pieces may then be thrown away or, if possible, recycled into new product. The sorting function may also include further sorting the complete plurality of product 136 between properly laser-etched and improperly laser-etched product. Again, the improperly laser-etched product may be thrown away of, if possible, recycled into new product. Thus, only complete, adequate product of the plurality of product 136 is provided directly to collector 112 or via a chute 144.

Collector 112 may collect and/or house plurality of product 136 provided by outlet 128. Collector 112 may use and/or include chute 144. However, chute 144 may be undesired and/or not needed such that outlet 128 directly supplies collector 112 with plurality of product 136. Collector 112 may be any suitable collection box. In an example, collector 112 is simply a large box to house and later ship plurality of product 136 within. In an example, collector 112 is a bed of a truck. In an example, collector 112 is the conveyor system of another machine. As explained above, laser-etching system 100 may be one of many systems in a production line. Thus, outlet 128 may be configured to supply plurality of product 136 to the inlet of a new system (e.g., collector 112 may be the inlet or hopper of this new system) or directly to a new conveyor system.

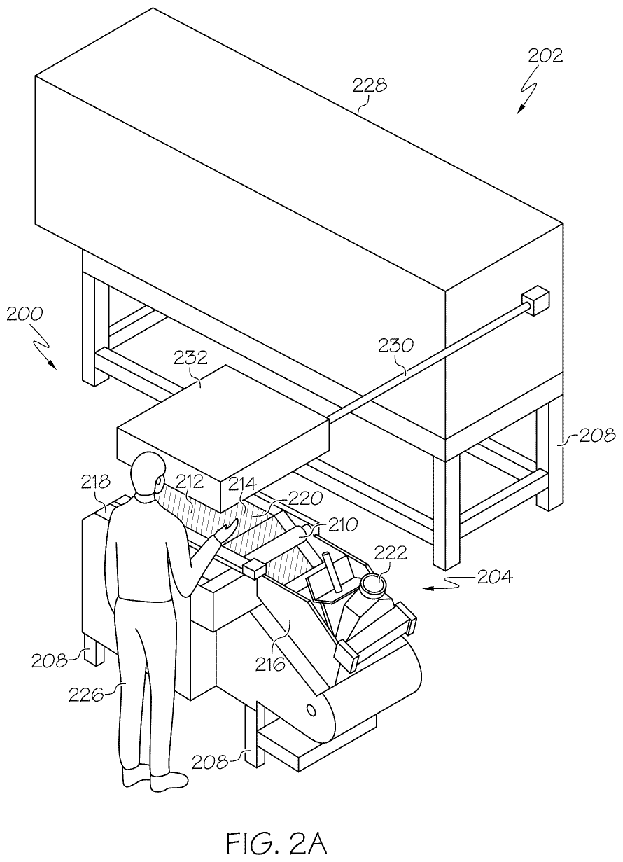

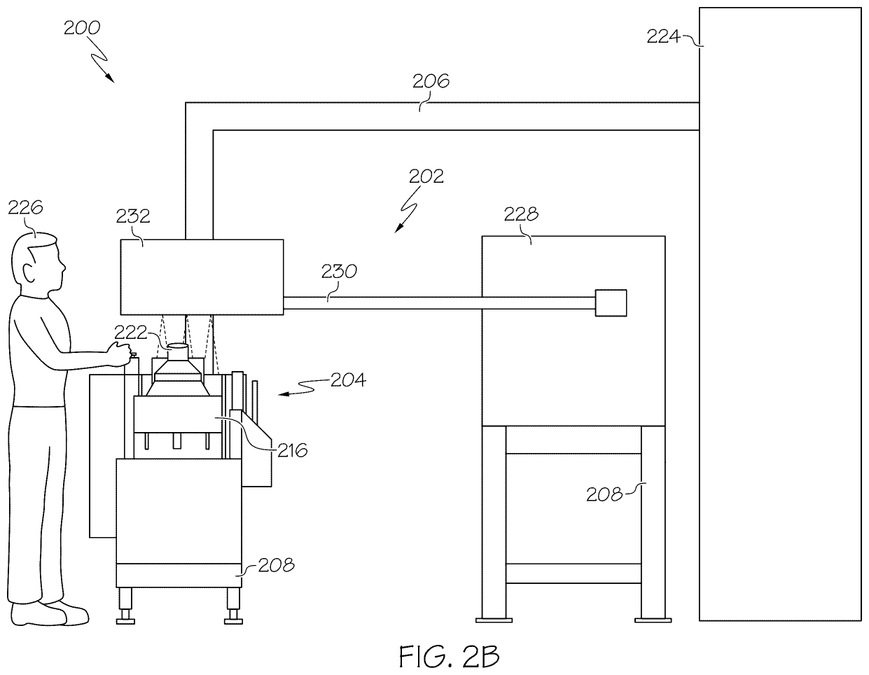

FIG. 2A is a perspective view of a laser-etching system according to aspects of the present disclosure. FIG. 2B is also a perspective view of a laser-etching system according to FIG. 2A. Laser-etching system 200 may include similar components as laser-etching system 100. However, the layout of laser-etching system 200 may be different when compared to laser-etching system 100. Specifically, laser-etching system 200 may be less compact and less effective with its physical footprint. Laser-etching system 200 may be used when dimensional constraints are not too restrictive. Laser-etching system 200 may include a laser system 202, a conveyor system sysem 204, a smoke extraction system 206 (FIG. 2B), a support structure 208, a hopper (not shown), a collector (not shown), a laser absorption plate (not shown), a roller 210, one or more user interfaces (not shown), conveyor system 212, carrier bars 214, inlet 216, outlet 218, transport path 220, one or more pieces of product (not shown), a chute 222, hazardous by-products (not shown), outside environment 224 (FIG. 2B), and a user 226. The components of laser-etching system 200 may have substantially similar functions as the corresponding components of laser-etching system 100. Additionally, roller 210, as described above, may perform the same functions as brush 116 (e.g., roller 210 is configured to direct product into cavities of the carrier bars 214).

The laser source of laser system 202 may be housed in a laser source box 228 separate to the rest of laser-etching system 200. A laser tube 230 may provide the laser beam from the laser source stored in the laser source box 228 to a beam segment box 232 configured to separate the laser beam into beam segments and direct the beam segments onto the product. Similar to laser system 102, laser system 202 may include one or more beam splitters to split the beam and one or more beam deflectors (such as one or more galvanometers) to direct the beam onto the product. The one or more beam splitters may be any device known in the art such as plate beam splitters, cube beam splitters, polarizing beam splitters, dichroic beam splitters, or any combination thereof.

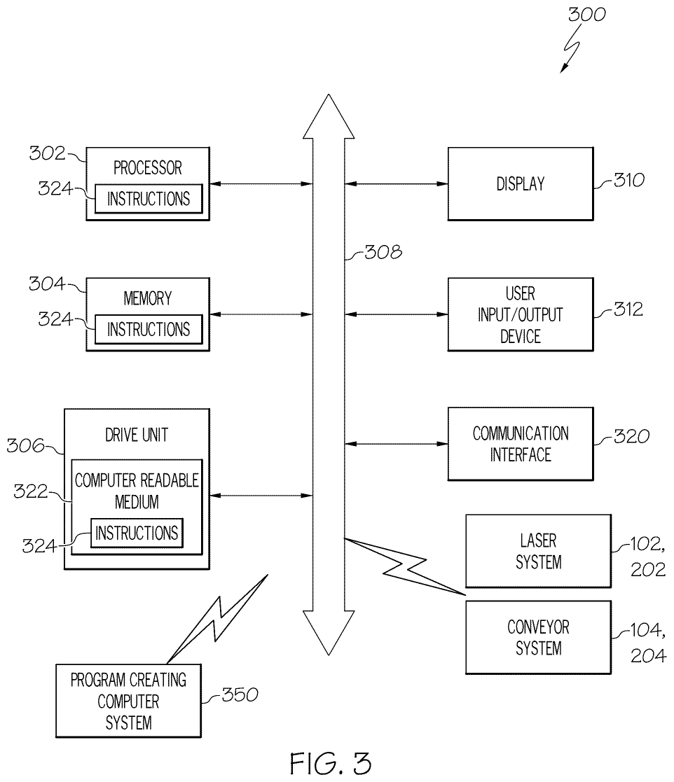

FIG. 3 illustrates an implementation of a computer system that executes techniques of a laser-etching system according to aspects of the present disclosure. For example, user interface 118 and/or user interface 120 may be the computer system 300. User interface 118 and/or user interface 120 may include less components than shown in FIG. 3. As such, the components illustrated in computer system 300 are not meant to be limiting and/or required in the present disclosure as it will be appreciated by a person in the art. Additionally, while computer system 300 is illustrated as the computer system for laser system 102 and/or conveyor system 104, laser system 102 and/or conveyor system 104 may have separate computer systems. In this way, computer system 300 may remotely connect to laser-etching system 100, allowing a user to remotely control the laser system 102 and/or conveyor system 104.

User interface 118 may be the same user interface as user interface 120 (e.g., the combined user interface of user interface 118 and user interface 120 performs functions performed by each user interface). Alternatively, as depicted in FIG. 1A, user interface 118 may be separate to user interface 120 (e.g., some of the functions of user interface 118 and user interface 120 may overlap but each have at least some unique functions). The computer system 300 may include a set of instructions that are executed to cause the laser-etching system 100 or laser-etching system 200 to perform certain functions. For example, computer system 300 may include instructions directed to laser system 102 (or laser system 202) and/or instructions directed to conveyor system 104 (or conveyor system 204). In an example, computer system 300 is directly interacted with by a user to program the different components of laser-etching system 100. In an example, computer system 300 is preprogrammed and uploads the programs for the different components of laser-etching system 100 to run.

In this way, computer system 300 may be physically connected to a program creating computer system 350 configured to create the programs. For example, the program creating computer system 350 may provide the programs to computer system 300 via electrical wires. In an aspect, the programs created on program creating computer system 350 are uploaded to computer system 300 via a network. In an aspect, the programs created on program creating computer system 350 are supplied to computer system 300 via a flash drive. It is contemplated in the present disclosure that computer system 300 performs the functions of program creating computer system 350 instead of a separate computer system doing so.

As illustrated in FIG. 3, the computer system 300 includes a processor 302, e.g., a central processing unit (CPU), a graphics processing unit (GPU), or both. The processor 302 is a component in a variety of systems. For example, the processor 302 is part of the laser system 102 and/or conveyor system 104. The processor 302 is one or more processors, digital signal processors, application specific integrated circuits, field programmable gate arrays, servers, networks, digital circuits, analog circuits, combinations thereof, or other now known or later developed devices for analyzing and processing data. The processor 302 implements a program, such as code generated manually (e.g., programmed).

The computer system 300 includes a memory 304 that communicates via bus 308. Memory 304 is a main memory, a static memory, or a dynamic memory. Memory 304 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of a processor, the system memory, or other memory. Memory 304 is an external storage device or database for storing data. Examples include a hard drive, flash drive, compact disc (CD), digital video disc (DVD), memory card, memory stick, floppy disc, universal serial bus (USB) memory device, or any other device operative to store data. The memory 304 is operable to store instructions executable by the processor 302. The functions, acts, or tasks illustrated in the figures or described herein are performed by processor 302 executing the instructions stored in memory 304. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 300 further includes a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 acts as an interface for the user to see the functioning of the processor 302, or specifically as an interface with the software stored in the memory 304 or in the drive unit 306.

Additionally or alternatively, the computer system 300 includes an input/output device 312 configured to allow a user to interact with any of the components of the computer system 300. The input/output device 312 is a number pad, a keyboard, a cursor control device, such as a mouse, a joystick, touch screen display, remote control, or any other device operative to interact with the computer system 300.

The computer system 300 also includes the drive unit 306 implemented as a disk or optical drive. The drive unit 306 includes a computer-readable medium 322 in which one or more sets of instructions 324, e.g. software, is embedded. Further, the sets of instructions 324 embodies one or more of the methods or logic as described herein. Instructions 324 resides completely or partially within memory 304 and/or within processor 302 during execution by the computer system 300. The memory 304 and the processor 302 also include computer-readable media as discussed above.

In some systems, computer-readable medium 322 includes the set of instructions 324 or receives and executes the set of instructions 324 responsive to a propagated signal so that laser system 102 and/or conveyor system 104 communicates data to computer system 300. Further, the sets of instructions 324 are transmitted or received via the communication port or interface 320, and/or using the bus 308. The communication port or interface 320 is a part of the processor 302 or is a separate component. The communication port or interface 320 is created in software or is a physical connection in hardware. The communication port or interface 320 is configured to connect with the laser system 102 and/or the conveyor system 104, display 310, or any other components in the computer system 300, or combinations thereof.

While the computer-readable medium 322 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 322 is non-transitory, and may be tangible.

The computer-readable medium 322 includes a solid-state memory such as a memory card or other package that houses one or more non-volatile read-only memories. The computer-readable medium 322 is a random-access memory or other volatile re-writable memory. Additionally or alternatively, the computer-readable medium 322 includes a magneto-optical or optical medium, such as a disk or tapes or other storage device to capture carrier wave signals such as a signal communicated over a transmission medium.

In an alternative implementation, dedicated hardware implementations, such as application specific integrated circuits (ASICs), programmable logic arrays, and other hardware devices, is constructed to implement one or more of the methods described herein. For example, laser system 102 may include an ASIC and conveyor system 104 may include a separate (or the same) ASIC. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Regardless of implementation (e.g., whether implemented via an ASIC, computer system 300, etc.), laser system 102 includes numerous programmable controls. For example, user interface 118 may turn laser system 102 on/off, control the one or more galvanometers, control the wattage produced by the laser source, control the amount of active beam splitters (to control how many beam segments are produced), control the penetration depth (e.g., rate of etching) of the laser, etc. User interface 120 may turn conveyor system 104 on/off, control the speed of conveyor system 104, control the angle of incline of inlet 126, etc. Laser-etching system 100 may be programmed to produce (and capable of producing) laser-etched product at a maximum rate of 1,000,000 objects per hour. Laser-etching system 100 may be programmed to produce (and capable of producing) laser-etched product at a maximum rate of 500,000 objects per hour. Laser-etching system 100 may be programmed to produce (and capable of producing) laser-etched product at a maximum rate of 750,000 objects per hour. As should be appreciated, laser-etching system 100 can produce laser-etched product at any rate below its maximum rate. All of the described functions (e.g., the functions of both user interface 118 and user interface 120) may be controlled by a singular user interface, such as computer system 300, an ASIC, or any combination of software, firmware, and hardware.

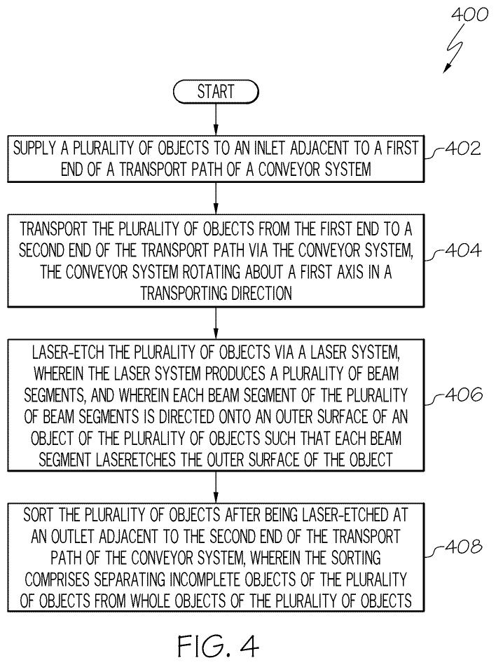

FIG. 4 is a flow chart 400 according to aspects of the present disclosure. Flow chart 400 may correspond to a method of laser-etching a plurality of objects. The method described by flow chart 400 may use components that have been previously described with respect to laser-etching system 100. Accordingly, the disclosure below uses the same reference labels as laser-etching system 100 when describing the various steps of flow chart 400, but flow chart 400 is not limited by the explicit components described in laser-etching system 100.
Step 402 may include supplying a plurality of objects (e.g., product 136) to an inlet 126 adjacent to a first end 132 of a transport path 130 of a conveyor system 104.
Step 404 may include transporting the plurality of objects 136 from the first end 132 to a second end 134 of the transport path 130 via the conveyor system 104. The conveyor system 104 may rotate about a first axis in a transporting direction.
Step 406 may include laser-etching the plurality of objects 136 via a laser system 102. The laser system 102 may produce a plurality of beam segments that are directed onto the outer surfaces of the plurality of objects 136 such that each beam segment laser-etches the outer surface of the product 136.
Step 408 may include sorting the plurality of objects 136 after being laser-etched at an outlet 128 adjacent to the second end 134 of the transport path 130 of the conveyor system 104. The outlet 128 may sort the product 136 by, for example, separating incomplete, broken, damaged, etc. product 136 from whole, complete, etc. product 136. The outlet 128 may provide the whole objects to a second conveyor system and/or a collector 112 via a chute 144. The method described may further include extracting smoke and/or particulates generated from laser-etching via a smoke extraction system 106. Moreover, the method may include controlling, via a user interface 118 and/or 120, the laser system 102 and/or the conveyor system 104 to turn the laser system 102 on and off and/or the conveyor system on and off.

It will be apparent to those skilled in the art that modifications may be made in the disclosed systems and methods without departing from the scope of the disclosure. Other aspects of the disclosure will be apparent to those skilled in the art from consideration of the specification and practice of the features disclosed herein. It is intended that the specification and embodiments be considered as exemplary only.

What is claimed is:

1. A system for laser-etching a plurality of objects, the system comprising:
a conveyor system with a transport path that transports the plurality of objects from a first end to a second end, the conveyor system rotating about a first axis in a transporting direction;
an inlet adjacent to the first end, the inlet grouping the plurality of objects for transportation on the conveyor system via the transport path;
an outlet adjacent to the second end, the outlet sorting the plurality of objects by separating incomplete objects of the plurality of objects from whole objects of the plurality of objects; and
a laser system configured to interact with the plurality of objects while the plurality of objects are on the transport path between the first end and the second end, wherein the laser system produces a plurality of beam segments, wherein each beam segment is configured to laser-etch an outer surface of an object of the plurality of objects.

2. The system of claim 1, wherein a hopper and/or a second conveyor system provides the plurality of objects to the inlet.

3. The system of claim 1, wherein the outlet provides the whole objects of the plurality of objects to a collection box and/or a second conveyor system.

4. The system of claim 1, the system further comprising:
a moving apparatus configured to move any one of the plurality of objects on the transport path to space apart the plurality of objects for reception of the plurality of beam segments.

5. The system of claim 1, the system further comprising:
a smoke extraction system configured to remove smoke and/or particulates from the system caused by the laser-etching.

6. The system of claim 1, the system further comprising:
a user interface configured to allow a user of the system to at least turn the laser system on, turn the laser system off, turn the conveyor system on, and turn the conveyor system off.

7. The system of claim 6, wherein the user interface includes a laser system user interface configured to allow the user of the system to control components of the laser system and a conveyor system user interface configured to allow the user of the system to control components of the conveyor system.

8. A method for laser-etching a plurality of objects, the method comprising:
supplying the plurality of objects to an inlet adjacent to a first end of a transport path of a conveyor system;
transporting the plurality of objects from the first end to a second end of the transport path via the conveyor system, the conveyor system rotating about a first axis in a transporting direction;
laser-etching the plurality of objects via a laser system, wherein the laser system produces a plurality of beam segments, and wherein each beam segment of the plurality of beam segments is directed onto an outer surface of an object of the plurality of objects such that each beam segment laser-etches the outer surface of the object; and
sorting the plurality of objects after being laser-etched at an outlet adjacent to the second end of the transport path of the conveyor system, wherein the sorting comprises separating incomplete objects of the plurality of objects from whole objects of the plurality of objects.

9. The method of claim 8, wherein the outlet is configured to provide the whole objects of the plurality of objects to a second conveyor system.

10. The method of claim 8, the method further comprising:
extracting smoke and/or particulates generated from the laser-etching via a smoke extraction system.

11. The method of claim 8, the method further comprising:
controlling, via a user interface, the laser system, wherein controlling the laser system includes at least one of turning the laser system on and turning the laser system off.

12. The method of claim 11, the method further comprising:
controlling, via the user interface, the conveyor system, wherein controlling the conveyor system includes at least one of turning the conveyor system on and turning the conveyor system off.

13. The method of claim 11, the method further comprising:
controlling, via a second user interface, the conveyor system, wherein controlling the conveyor system includes at least one of turning the conveyor system on and turning the conveyor system off.

14. A system for laser-etching a plurality of objects, the system comprising:
a conveyor system with a transport path that transports the plurality of objects from a first end to a second end, the conveyor system rotating about a first axis in a transporting direction;
a moving apparatus configured to move any one of the plurality of objects on top of another one of the plurality of objects on the transport path;
a laser system configured to interact with the plurality of objects while the plurality of objects are on the transport path between the first end and the second end, wherein the laser system produces one or more beam segments, and wherein each beam segment of the one or more beam segments is configured to laser-etch an outer surface of an object of the plurality of objects; and
a smoke extraction system configured to remove smoke and/or particulates from the system caused by the laser-etching.

15. The system of claim 14, the system further comprising:
an inlet adjacent to the first end, the inlet grouping the plurality of objects for transportation on the conveyor system via the transport path, wherein a hopper and/or a second conveyor system provides the plurality of objects to the inlet.

16. The system of claim 15, the system further comprising:
an outlet adjacent to the second end, the outlet sorting the plurality of objects by separating incomplete objects of the plurality of objects from whole objects of the plurality of objects.

17. The system of claim 16, wherein the outlet provides the whole objects of the plurality of objects to a collection box and/or a second conveyor system.

18. The system of claim 14, the system further comprising:
a user interface configured to allow a user of the system to at least turn the laser system on, turn the laser system off, turn the conveyor system on, and/or turn the conveyor system off.

19. The system of claim 18, wherein the user interface includes a laser system user interface configured to allow the user of the system to control components of the laser system and a conveyor system user interface configured to allow the user of the system to control components of the conveyor system.

20. The system of claim 1, wherein the system is configured to laser-etch at a rate of 750,000 objects per hour.
